(19) United States
(12) Patent Application Publication
(10) Pub. No.: US 2011/0026115 A1
(43) Pub. Date: Feb. 3, 2011

(54) STEREOSCOPIC PRINT

(75) Inventor: Hideki Yamazaki, Saitama-Ken (JP)

Correspondence Address: BURR & BROWN, PO BOX 7068, SYRACUSE, NY, 13261-7068, US

(73) Assignee: Dai Nippon Printing Co.,Ltd., Shinjuku-ku (JP)

(21) Appl. No.: 12/671,966

(22) PCT Filed: Nov. 7, 2008
(86) PCT No.: PCT/JP2008/070325

§ 371 Date: Feb. 3, 2010

(30) Foreign Application Priority Data
Jan. 8, 2008 (JP) 2008-001153

(51) Int. Cl. G02B 27/22

(52) U.S. Cl. 359/463

(57) ABSTRACT

The present invention provides stereoscopic prints with reduced image coarseness. A stereoscopic print comprises a lenticular lens sheet and a dot image print that is glued to the back surface of the lenticular lens sheet. Multiple image strips that form the dot image print each include a smallest unit that enables tone representation, and for each color plate, multiple reference positions are set in each of the smallest units. In forming the dot image print, amplitude-modulated screening is employed to print dots in longitudinal directions of the multiple image strips from each of the reference positions.

### TECHNICAL FIELD

The present invention relates to stereoscopic prints that involve the use of lenticular lenses and more particularly to dot printing technologies for producing dot image prints that are placed on the back of lenticular lenses and express color tones.

### BACKGROUND ART

To make posters or advertisement prints more conspicuous to viewers for the purpose of promoting products or services, stereoscopic prints have heretofore been used, which involve the use of lenticular lenses so that the viewers can stereoscopically perceive symbolic images of the products or services. Such stereoscopic prints are produced by dividing images acquired at different angles into strips and arraying the strips on the back of lenticular lenses such that the strips are positioned along the half-cylindrical shapes of the lenticular lenses (for example, see Patent Documents 1 and 2).

Known dot printing methods for producing images to be placed on the back of lenticular lenses include FM (frequency-modulated) screening and AM (amplitude-modulated) screening (for example, see Patent Document 1). FM screening achieves tone representation by the density of dots of the same size, and AM screening, in contrast, by the size of dots. In addition, as a dot printing method for an image strip, a method has been proposed that employs AM screening to print dots in the area of the tone-representing smallest unit in longitudinal directions of the area from the center of the area. Another proposed method employs FM screening to print dots in the area of the tone-representing smallest unit such that the dots are spaced from each other (see Patent Document 2).

Patent Document 1: Japanese Patent Laid-Open No. H09-061950

Patent Document 2: Japanese Patent Laid-Open No. 2007-233105

Conventional stereoscopic prints, however, entail the following drawbacks. Because AM screening has been employed to print dots in the area of the tone-representing smallest unit in longitudinal directions of the area from one central point of the area, the dots tend to center around the central point, which makes the bare color of the printing paper easily noticeable at the edge portions of the area and accordingly makes the image look coarse. In addition, when dots are printed such that they are spaced from each other, the resolution of prints depends on the resolution of printers or press printers, or on whether such a device can print each dot clearly and reliably, thus making it difficult to achieve higher resolution printing.

### DISCLOSURE OF THE INVENTION

In view of the above, an object of the invention is thus to provide stereoscopic prints with reduced image coarseness.

A stereoscopic print according to the invention comprises: a lenticular lens sheet that is formed by arranging a plurality of half-cylindrical lenses in a continuous manner; and a dot image print arranged on the back surface of the lenticular lens sheet, the dot image print being formed by arranging a plurality of image strips in a continuous manner such that particular image strip groups are each arranged exclusively for one of the plurality of half-cylindrical lenses, wherein: the plurality of image strips each include a smallest unit that enables tone representation; for each color plate, a plurality of reference positions are set in each of the smallest units; and amplitude-modulated screening is employed to print dots continuously in longitudinal directions of the plurality of image strips from each of the plurality of reference positions.

As stated above, in the above stereoscopic print, the plurality of image strips of the dot image print each include a smallest unit that enables tone representation, and for each color plate, a plurality of reference positions are set in each of the smallest units. Further, AM screening is employed to print dots continuously in longitudinal directions of the plurality of image strips from each of the plurality of reference positions. The above configuration helps reduce the coarseness of the image when viewed through the lenticular lens sheet and allows the viewer to stereoscopically perceive the dot image print.

In the above stereoscopic print, preferably, the plurality of reference positions are arranged in the form of straight lines for each of the particular image strip groups that are each arranged for one of the plurality of half-cylindrical lenses. This configuration allows pixels to be printed to become positionally continuous near the plurality of reference positions, thereby connecting the printing areas together. This in turn enables clear dot printing with the use of a printer or press printer and tone representation which is superior to the resolution of the printer or press printer.

Moreover, in the above stereoscopic print, the plurality of reference positions arranged in the form of straight lines are preferably located at vertically different positions among the particular image strip groups that are each arranged next to each other. Although the base color of the dot image print tends to be more noticeable at positions farther away from the plurality of reference positions, varying the vertical positions of the plurality of reference positions for each image strip group makes the base color of the dot image print appear in a discontinuous manner.

Another stereoscopic print according to the invention comprises: a lenticular lens sheet that is formed by arranging a plurality of half-cylindrical lenses in a continuous manner; and a dot image print arranged on the back surface of the lenticular lens sheet, the dot image print being formed by arranging a plurality of image strips in a continuous manner such that a particular image strip group is arranged exclusively for each of the plurality of half-cylindrical lenses, wherein: the plurality of image strips each include a smallest unit that enables tone representation; for each color plate, at least one reference position is set in each of the smallest units; amplitude-modulated screening is employed to print dots continuously in longitudinal directions of the plurality of image strips from each of the reference positions; and the number of the reference positions differs depending on the number of dots to be printed.

As stated above, in the above stereoscopic print, the plurality of image strips of the dot image print each include a smallest unit that enables tone representation, and for each color plate, at least one reference position is set in each of the smallest units. Further, AM screening is employed to print dots continuously in longitudinal directions of the plurality of image strips from each of the plurality of reference positions, and the number of the reference positions differs among the plurality of image strips depending on the number of dots to be printed. The above configuration allows the reference positions to be dispersed in the dot image print. Accordingly, the coarseness of the image can be reduced when viewed through the lenticular lens sheet, and the viewer can perceive the dot image print stereoscopically.

Still another stereoscopic print according to the invention comprises: a lenticular lens sheet that is formed by arranging a plurality of half-cylindrical lenses in a continuous manner; and a dot image print arranged on the back surface of the lenticular lens sheet, the dot image print being formed by arranging a plurality of image strips in a continuous manner such that a particular image strip group is arranged exclusively for each of the plurality of half-cylindrical lenses, wherein: the plurality of image strips each include a smallest unit that enables tone representation; for each color plate, a plurality of reference positions are set in each of the smallest units; amplitude-modulated screening is employed to print dots continuously in longitudinal directions of the plurality of image strips from each of the plurality of reference positions; and the plurality of reference positions are located at vertically different positions among the plurality of image strips.

As stated above, in the above stereoscopic print, the plurality of image strips of the dot image print each include a smallest unit that enables tone representation, and for each color plate, a plurality of reference positions are set in each of the smallest units. Further, AM screening is employed to print dots continuously in longitudinal directions of the plurality of image strips from each of the plurality of reference positions. Furthermore, the plurality of reference positions are located at vertically different positions among the plurality of image strips. The above configuration helps reduce the coarseness of the image when viewed through the lenticular lens sheet and allows the viewer to stereoscopically perceive the dot image print.

In accordance with the above-described invention, it is possible to provide stereoscopic prints with reduced image coarseness.

### BRIEF DESCRIPTION OF THE DRAWINGS

FIGS. 1(A), 1(B), and 1(C) illustrate the method of producing a dot image print to be used for a stereoscopic print, wherein FIG. 1(A) shows how to acquire images of a subject with the use of a stereo camera, FIG. 1(B) shows how to divide the images acquired by the multiple cameras of the stereo camera to form a dot image print, and FIG. 1(C) is a diagram illustrating the dot image print formed by the divided image strips.

FIG. 2 is an exploded perspective view of a stereoscopic print.

FIGS. 3(A) and 3(B) are diagrams to illustrate a stereoscopic print according to a first embodiment of the invention, wherein FIG. 3(A) is a diagram illustrating a dot image print, and FIG. 3(B) is a diagram showing the arrangement of a lenticular lens for the dot image print.

FIGS. 4(A), 4(B), 4(C), and 4(D) are diagrams to illustrate stereoscopic prints according to embodiments of the invention, wherein FIG. 4(A) is a diagram to illustrate a stereoscopic print according to the first embodiment, FIG. 4(B) is a diagram to illustrate a stereoscopic print according to a second embodiment, FIG. 4(C) is a diagram to illustrate a stereoscopic print according to a third embodiment, and FIG. 4(D) is a diagram to illustrate a stereoscopic print according to a fourth embodiment.

FIGS. 5(A) and 5(B) are diagrams to illustrate stereoscopic prints according to embodiments of the invention, wherein FIG. 5(A) is a diagram to illustrate a stereoscopic print according to a fifth embodiment, and FIG. 5(B) is a diagram to illustrate a stereoscopic print according to a sixth embodiment.

FIG. 6 is a diagram to illustrate reference positions for a dot image print of a stereoscopic print according to a seventh embodiment.

FIG. 7 is a diagram to illustrate a stereoscopic print according to the seventh embodiment.

### BEST MODE FOR CARRYING OUT THE INVENTION

Stereoscopic prints according to preferred embodiments of the invention will now be described with reference to the accompanying drawings.

### First Embodiment

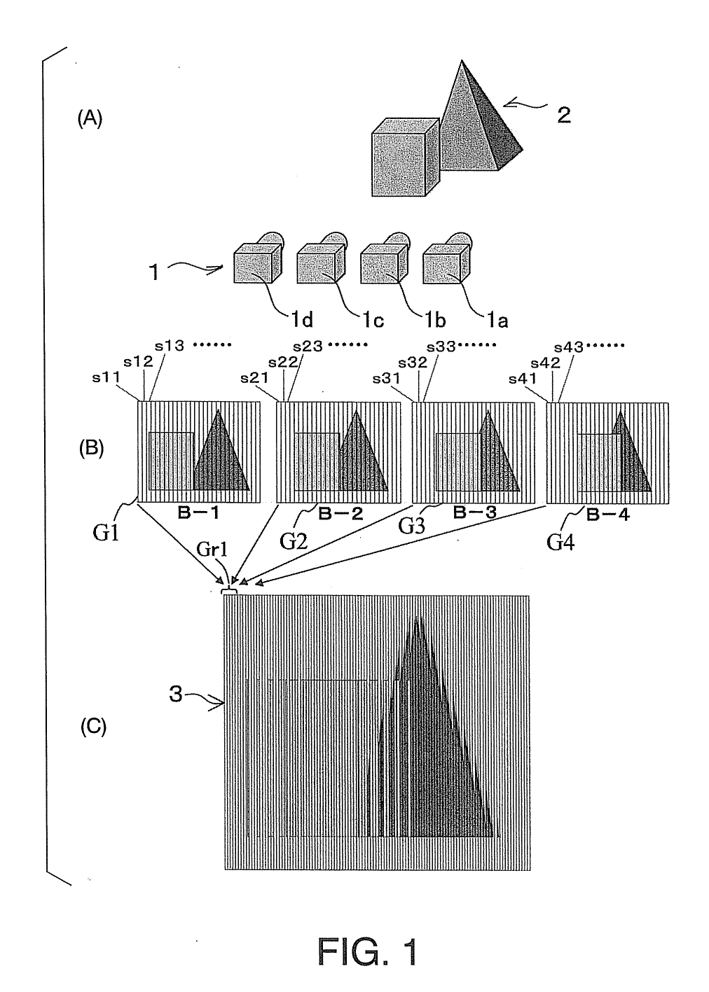

First, a stereoscopic print according to a first embodiment will be described. FIGS. 1(A) to 1(C) illustrate the method of producing a dot image print 3 to be used for a stereoscopic print. As shown in FIG. 1(A), cameras 1a, 1b, 1c, and 1d of a stereo camera 1 are arranged laterally to acquire images of a subject 2. FIG. 1(B) illustrates the images acquired by the respective cameras 1a, 1b, 1c, and 1d. ‘B-1’ of FIG. 1(B) illustrates an image G1 acquired by the camera 1a, ‘B-2’ an image G2 acquired by the camera 1b, ‘B-3’ an image G3 acquired by the camera 1c, and ‘B-4’ an image G4 acquired by the camera 1d. The images G1 to G4 are vertically divided into strips based on the number of half-cylindrical lenses of a lenticular lens sheet to be used.

As shown in FIG. 1(B), the image G1 of B-1 are divided into image strips s11, s12, s13, . . . (from left to right). Likewise, the image G2 of B-2 are divided into image strips s21, s22, s23, . . . ; the image G3 of B-3 into image strips s31, s32, s33, . . . ; and the image G4 of B-4 into image strips s41, s42, s43, . . . .

Then, as shown in FIG. 1(C), the leftmost image strips are taken one by one first from the image G1 and then from the images G2, G3, and G4 and arranged in this order. That is, the image strips are arranged in the order of s11, s21, s31, s41, s12, s22, s32, s42, s13, s23, s33, s43, s14, s24, s34, s44, . . . (from left to right).

Assume then that the image strips s11, s21, s31, and s41 constitute a group Gr1; s12, s22, s32, and s42 a group Gr2; s13, s23, s33, and s43 a group Gr3; and s14, s24, s34, and s44 a group Gr4 (the same applies to the subsequent image strips). The dot image print 3 is formed by placing each group Gr on the back of each half-cylindrical lens of a lenticular lens sheet and by increasing or reducing the scales of the image strips constituting each group Gr vertically or horizontally such that the all the groups Gr cover the entire back surface of the lenticular lens sheet.

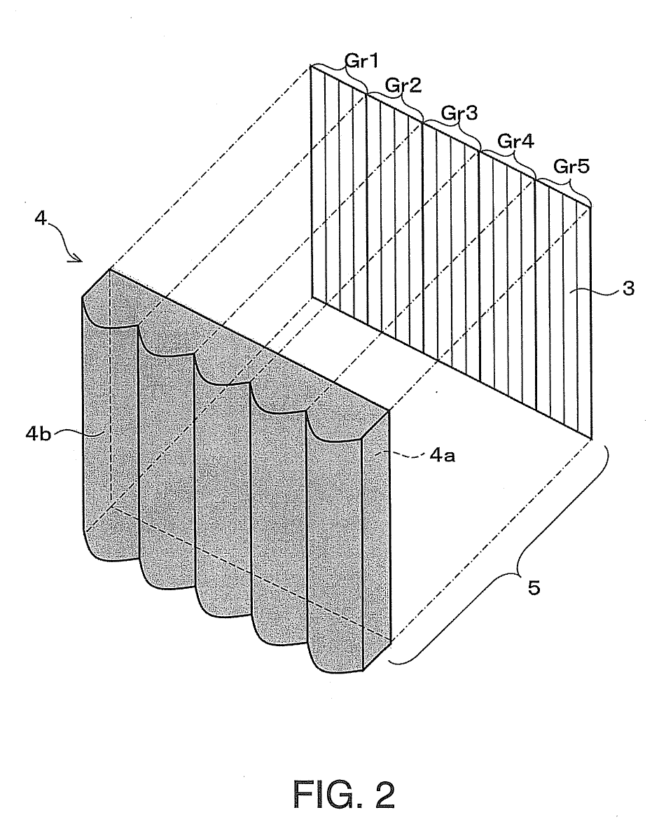

With reference to FIG. 2, the placement of the dot image print 3 on the back surface 4a of a lenticular lens sheet 4 is discussed next. FIG. 2 is an exploded perspective view of a stereoscopic print 5. As shown in FIG. 2, the dot image print 3 is made up of the adjacently placed groups Gr. The image strips constituting each group Gr are aligned so as to fit the back surface 4a of a half-cylindrical lens 4b of the lenticular lens sheet 4 and then glued to the back surface 4a of that half-cylindrical lens 4b.

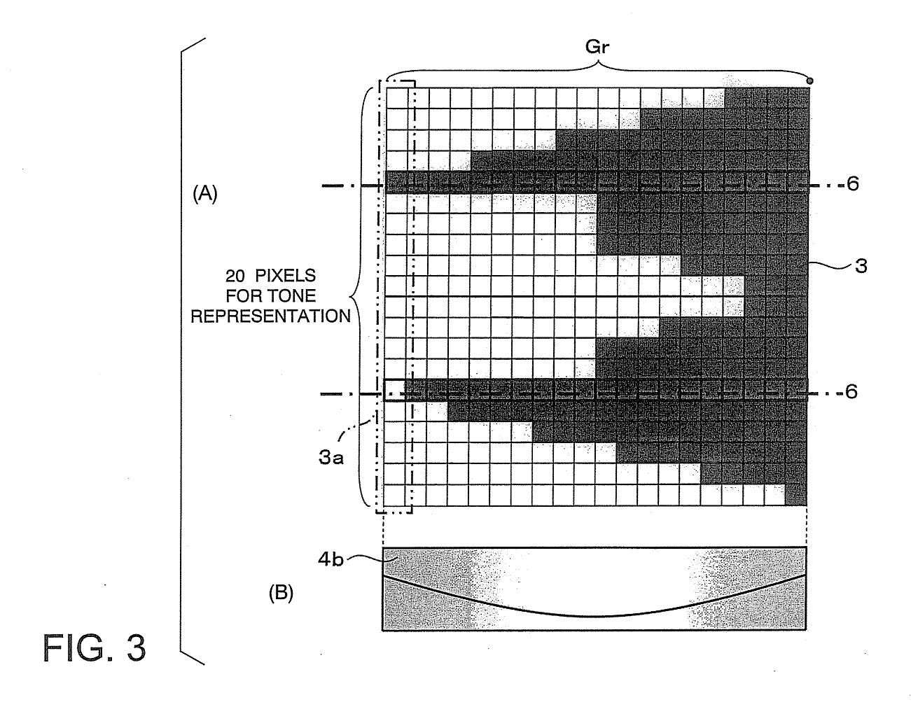

With reference now to FIG. 3, the method of forming the dot image print 3 by dot printing is described. FIG. 3(A) is a diagram to illustrate dot printing for the dot image print 3. FIG. 3(B) illustrates the positional relationship of a half-cylindrical lens 4b of the lenticular lens sheet 4 that is glued to the dot image print 3.

The following explanation is based on the assumption that twenty image strips are glued to the back surface of one half-cylindrical lens 4b and that each image strip consists of twenty vertically aligned pixels and serves as a smallest unit (area) 3a that enables tone representation. As shown in FIG. 3(A), the twenty image strips are arranged laterally, and each image strip consists of twenty vertically aligned pixels. In producing the image strips, any one or more of color plates out of CMYK color plates are used to print dots in a lattice pattern according to the tone levels of the plate(s). Note that FIG. 3(A) illustrates printing positions only for one color plate. Also, note that the pixels shown in FIG. 3(A) are arranged such that each of the pixels is in contact with its adjacent pixels. Further, each of the pixels corresponds to a dot in dot printing.

In the example shown in FIG. 3(A), to print dots on a tone-representing smallest unit 3a with the use of a particular color plate, two reference lines 6 are set at two positions of the smallest unit 3a (image strip). One position is located down from the upper edge of the image strip by a quarter length of the image strip, and the other is located above from the lower edge of the image strip by a quarter length of the image strip. The positions of the pixels on the reference lines 6 are reference positions from which dots are printed in longitudinal directions of the image strip, i.e., in upper and lower directions from the reference positions. The above means that pairs of upper and lower reference positions are arranged in the form of two lateral lines across multiple image strips. Pixels to be printed are divided into two pixel groups for the respective upper and lower reference positions based on the tone levels of a particular color plate, and dots are printed in upper and lower directions from the reference positions for as many pixels as are to be printed.

When the dot image print 3 is to be produced by multiple color plates selected from among CMYK plates, the reference lines 6 can be located at the same positions for the selected color plates. Alternatively, the reference lines 6 can be located at different positions for the selected color plates so that dots are dispersed enough to hide the bare color of the printing paper.

As explained above, the image strips of the dot image print 3, each of which constitutes a tone-representing smallest unit 3a, are produced by employing AM (amplitude-modulated) screening to print dots such that the dots are formed in longitudinal directions of the image strips from multiple reference positions, which positions are used as reference positions for each color plate. This helps reduce the coarseness of the image when viewed through the lenticular lens sheet 4 and allows the viewer to stereoscopically perceive the dot image print 3. Moreover, since the reference positions are arranged continuously in the form of two lateral lines, pixels to be printed become positionally continuous near the reference positions, thereby connecting the printing areas together. This enables clear dot printing with the use of a printer or press printer and tone representation which is superior to the resolution of the printer or press printer.

In the above-described first embodiment shown in FIG. 3(A), the number of pixels to be printed for producing an image strip is evenly divided according to the number of reference positions from which to start printing (in this case, the number of reference positions is two). However, the number of pixels to be printed for producing an image strip may not necessarily be divided evenly. A possible method in that case is to beforehand determine the minimum number of pixels to be allocated to each reference position. When the number of pixels to be printed falls short of that number, all the pixels can be allocated to one reference position, and no printing is performed for the other reference position. When, on the other hand, the number of pixels to be printed exceeds the minimum number, the pixels can be allocated evenly to each reference position. Another possible method is to allocate pixels to each reference position at random. The allocation in this case can be completely random allocation or random allocation with limitations. An example of the latter case would be to beforehand determine the minimum number of pixels to be allocated to each reference position. When the number of pixels to be printed falls short of that number, all the pixels can be allocated to one reference position, and no printing is performed for the other reference position. When, on the other hand, the number of pixels to be printed exceeds the minimum number, only the extra pixels that exceed the minimum number can be allocated at random.

### Second Embodiment

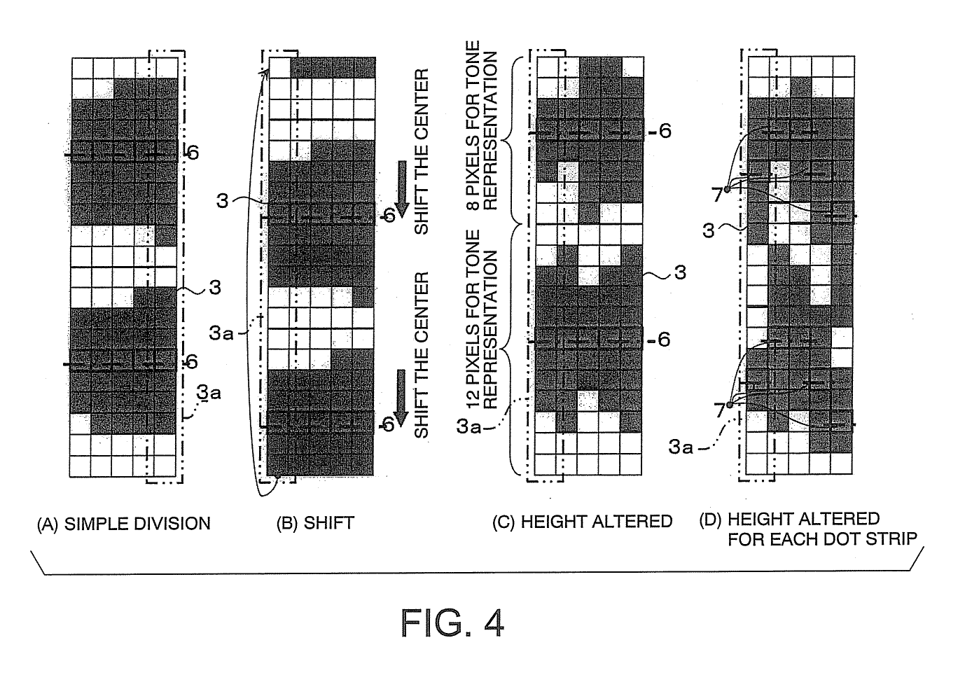

With reference now to FIG. 4(B), the method of forming the dot image print 3 by dot printing according to a second embodiment will be described. In the first embodiment, as shown in FIG. 4(A), the two reference lines 6 are set at two positions of an image strip with one position located down from the upper edge of the image strip by a quarter length of the image strip and the other located above from the lower edge of the image strip by a quarter length of the image strip. However, the positions of the reference lines 6 are not limited to the above positions. In the second embodiment shown in FIG. 4(B), the reference lines 6 are instead shifted from the positions of the reference lines 6 of the first embodiment. In that case, if any pixels remain to be printed when the printing position reaches the position of the uppermost pixel of an image strip that consists of twenty vertically aligned pixels, the remaining pixels are then printed upward from the position of the lowermost pixel of that image strip. If, on the other hand, any pixels remain to be printed when the printing position reaches the position of the lowermost pixel of an image strip that consists of twenty vertically aligned pixels, the remaining pixels are then printed downward from the position of the uppermost pixel of that image strip.

Further, it is preferred that the positions of the reference lines 6 (linearly arranged reference positions) be different among image strip groups that are each arranged for one half-cylindrical lens 4b. Although the base color of the dot image print 3 tends to be more noticeable at positions farther away from the reference positions, varying the vertical positions of the reference lines 6 for each image strip group makes the base color of the dot image print 3 appear in a discontinuous manner.

When the dot image print 3 is to be produced by multiple color plates, the base color of the dot image print 3 becomes more unnoticeable by varying the vertical positions of the reference lines 6 for each color plate so that dots are dispersed.

In the above-described second embodiment shown in FIG. 4(B), the number of pixels to be printed for producing an image strip is evenly divided according to the number of reference positions from which to start printing (in this case, the number of reference positions is two). However, the number of pixels to be printed for producing an image strip may not necessarily be divided evenly, as explained above by the modification examples of the first embodiment. A possible method in that case is to beforehand determine the minimum number of pixels to be allocated to each reference position. When the number of pixels to be printed falls short of that number, all the pixels can be allocated to one reference position, and no printing is performed for the other reference position. When, on the other hand, the number of pixels to be printed exceeds the minimum number, the pixels can be allocated evenly to each reference position. Another possible method is to allocate pixels to each reference position at random. The allocation in this case can be completely random allocation or random allocation with limitations. An example of the latter case would be to beforehand determine the minimum number of pixels to be allocated to each reference position. When the number of pixels to be printed falls short of that number, all the pixels can be allocated to one reference position, and no printing is performed for the other reference position. When, on the other hand, the number of pixels to be printed exceeds the minimum number, only the extra pixels that exceed the minimum number can be allocated at random.

### Third Embodiment

With reference now to FIG. 4(C), the method of forming the dot image print 3 by dot printing according to a third embodiment will be described. In the first embodiment, as shown in FIG. 4(A), pixels to be printed are divided almost evenly by setting the two reference lines 6 at two positions of an image strip such that one position is located down from the upper edge of the image strip by a quarter length of the image strip and the other is located above from the lower edge of the image strip by a quarter length of the image strip. Alternatively, in the third embodiment shown in FIG. 4(C), tone-representing pixels to be allocated to the upper and lower reference lines 6 are divided unevenly, e.g., into eight and twelve pixels, and each of the reference lines 6 is set at the middle of each of the vertically divided pixel groups. In this case, pixels to be printed for producing an image strip can be allocated arbitrarily to each of the reference lines 6.

It is preferred that the ratio between the number of tone-representing pixels to be allocated to the upper reference line 6 and the number of tone-representing pixels to be allocated to the lower reference line 6 vary among image strip groups that are each arranged for one half-cylindrical lens 4b. This makes the positions of the reference lines 6 (linearly arranged reference positions) different among image strip groups that are each arranged for one half-cylindrical lens 4b, thereby causing the base color of the dot image print 3 to appear in a discontinuous manner. Also, similar to the above embodiments, when the dot image print 3 is to be produced by multiple color plates, the base color of the dot image print 3 becomes more unnoticeable by varying the vertical positions of the reference lines 6 for each color plate so that dots are dispersed.

In the above-described third embodiment, pixels to be printed for producing an image strip are allocated arbitrarily to each reference position from which to start printing. Those pixels can also be allocated based on the predetermined ratio between the number of pixels to be allocated to the upper reference line 6 and the number of pixels to be allocated to the lower reference line 6. In addition, when those pixels are to be allocated arbitrarily, an upper limit may be placed on the number of pixels to be allocated. For instance, a possible method in that case is to beforehand determine the minimum number of pixels to be allocated to each reference position. When the number of pixels to be printed falls short of that number, all the pixels can be allocated to one reference position, and no printing is performed for the other reference position. When, on the other hand, the number of pixels to be printed exceeds the minimum number, only the extra pixels that exceed the minimum number can be allocated at random.

Moreover, as in the second embodiment, the reference positions can be shifted vertically. In that case, if any pixels remain to be printed when the printing position reaches the position of the uppermost pixel of an image strip that consists of twenty vertically aligned pixels, the remaining pixels are then printed upward from the position of the lowermost pixel of that image strip. If, on the other hand, any pixels remain to be printed when the printing position reaches the position of the lowermost pixel of an image strip that consists of twenty vertically aligned pixels, the remaining pixels are then printed downward from the position of the uppermost pixel of that image strip.

### Fourth Embodiment

With reference now to FIG. 4(D), the method of forming the dot image print 3 by dot printing according to a fourth embodiment will be described. In the first embodiment, as shown in FIG. 4(A), the reference positions are arranged linearly on the reference lines 6. Alternatively, in the fourth embodiment shown in FIG. 4(D), reference positions 7 are arranged at random for each image strip. In this case, pixels to be printed for producing an image strip can be allocated arbitrarily to each reference line 6. This configuration helps reduce the coarseness of the image when viewed through the lenticular lens sheet 4 and allows the viewer to stereoscopically perceive the dot image print 3.

When the dot image print 3 is to be produced by multiple color plates, the base color of the dot image print 3 becomes more unnoticeable by setting the reference positions at random for each color plate so that dots are dispersed.

In the above-described fourth embodiment, pixels to be printed for producing an image strip are allocated arbitrarily to each reference position from which to start printing. Similar to one of the modification examples of the third embodiment, those pixels can also be allocated based on the predetermined ratio between the number of pixels to be allocated to the upper reference line 6 and the number of pixels to be allocated to the lower reference line 6. In addition, when those pixels are to be allocated arbitrarily, an upper limit may be placed on the number of pixels to be allocated. For instance, a possible method in that case is to beforehand determine the minimum number of pixels to be allocated to each reference position. When the number of pixels to be printed falls short of that number, all the pixels can be allocated to one reference position, and no printing is performed for the other reference position. When, on the other hand, the number of pixels to be printed exceeds the minimum number, only the extra pixels that exceed the minimum number can be allocated at random.

Moreover, as in the second embodiment, the reference positions can be shifted vertically. In that case, if any pixels remain to be printed when the printing position reaches the position of the uppermost pixel of an image strip that consists of twenty vertically aligned pixels, the remaining pixels are then printed upward from the position of the lowermost pixel of that image strip. If, on the other hand, any pixels remain to be printed when the printing position reaches the position of the lowermost pixel of an image strip, the remaining pixels are then printed downward from the position of the uppermost pixel of that image strip.

### Fifth Embodiment

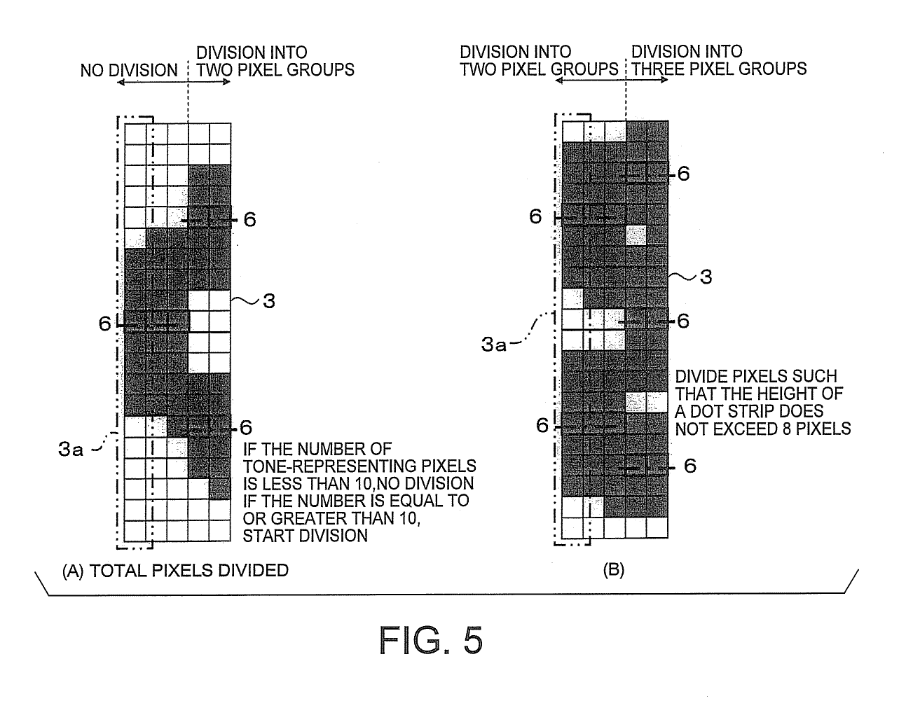

With reference now to FIG. 5(A), the method of forming the dot image print 3 by dot printing according to a fifth embodiment will be described. In the fifth embodiment, when the number of pixels to be printed for producing a tone-representing smallest unit (area) 3a, or an image strip, is less than a given number (e.g., less than ten), one reference line 6 is set, and the pixel on that reference line 6 is defined as a reference position. Dots are printed in longitudinal directions (upward and downward directions) of the image strip from the reference position. When, on the other hand, the number of pixels to be printed for producing the tone-representing smallest unit (area) 3a, or an image strip, is equal to or greater than a given number (e.g., ten), two reference lines 6 are set, and the pixels on those reference lines 6 are defined as reference positions. Dots are printed in longitudinal directions (upward and downward directions) of the image strip from the reference positions.

Thus, the number of reference positions varies among image strips depending on the number of dots to be printed. Accordingly, it follows that reference positions are dispersed in the dot image print 3. This helps reduce the coarseness of the image when viewed through the lenticular lens sheet 4 and allows the viewer to stereoscopically perceive the dot image print 3.

In the above-described fifth embodiment shown in FIG. 5(A), pixels to be printed for producing an image strip are evenly allocated to reference positions from which to start printing. However, the pixels may not necessarily be allocated evenly. A possible method in that case is to beforehand determine the minimum number of pixels to be allocated to each reference position. Only the extra pixels that exceed the minimum number can be allocated at random.

Moreover, as in the second embodiment, reference positions can be shifted vertically. In that case, if any pixels remain to be printed when the printing position reaches the position of the uppermost pixel of an image strip that consists of twenty vertically aligned pixels, the remaining pixels are then printed upward from the position of the lowermost pixel of that image strip. If, on the other hand, any pixels remain to be printed when the printing position reaches the position of the lowermost pixel of an image strip that consists of twenty vertically aligned pixels, the remaining pixels are then printed downward from the position of the uppermost pixel of that image strip.

### Sixth Embodiment

With reference now to FIG. 5(B), the method of forming the dot image print 3 by dot printing according to a sixth embodiment will be described. In the sixth embodiment, an upper limit is placed on the number of pixels (dots) to be continuously printed for producing a tone-representing smallest unit (area) 3a, or an image strip (for example, the upper limit can be eight pixels). When the number of pixels to be continuously printed exceeds the upper limit, the number of reference lines 6 is increased, for example, from two to three or four.

By thus increasing the number of reference lines 6 when the number of pixels to be continuously printed exceeds an upper limit, reference positions and dots can be dispersed, as in the fifth embodiment. This helps reduce the coarseness of the image when viewed through the lenticular lens sheet 4 and allows the viewer to stereoscopically perceive the dot image print 3.

In the above-described sixth embodiment shown in FIG. 5(B), pixels to be printed for producing an image strip are evenly allocated to reference positions from which to start printing. However, the pixels may not necessarily be allocated evenly. A possible method in that case is to beforehand determine the minimum number of pixels to be allocated to each reference position. Only the extra pixels that exceed the minimum number can be allocated at random.

Moreover, as in the second embodiment, reference positions can be shifted vertically. In that case, if any pixels remain to be printed when the printing position reaches the position of the uppermost pixel of an image strip that consists of twenty vertically aligned pixels, the remaining pixels are then printed upward from the position of the lowermost pixel of that image strip. If, on the other hand, any pixels remain to be printed when the printing position reaches the position of the lowermost pixel of an image strip that consists of twenty vertically aligned pixels, the remaining pixels are then printed downward from the position of the uppermost pixel of that image strip.

### Seventh Embodiment

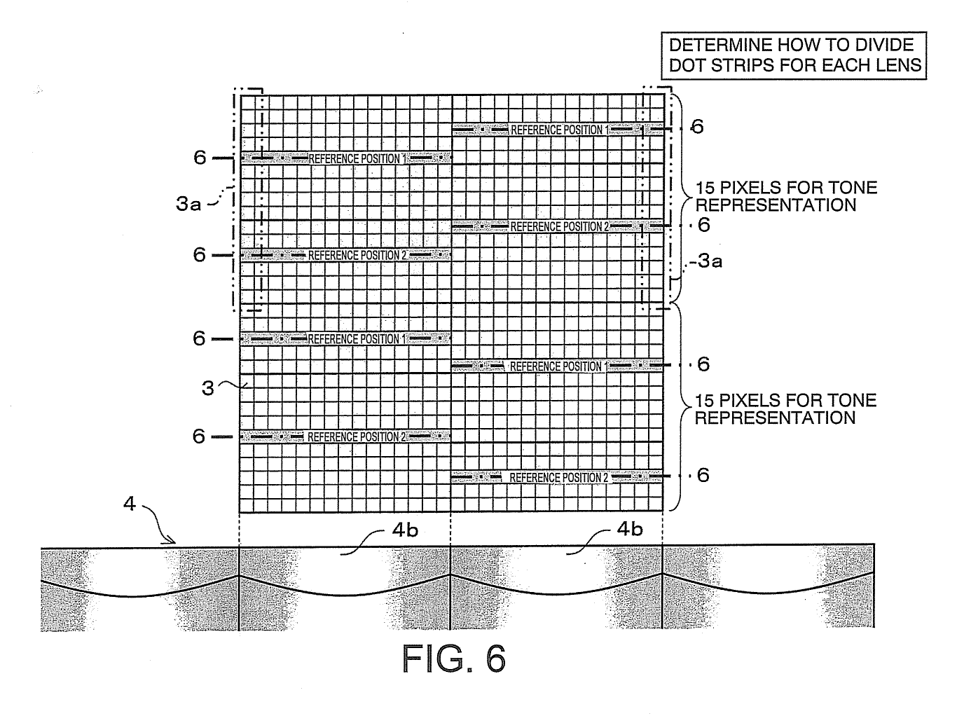

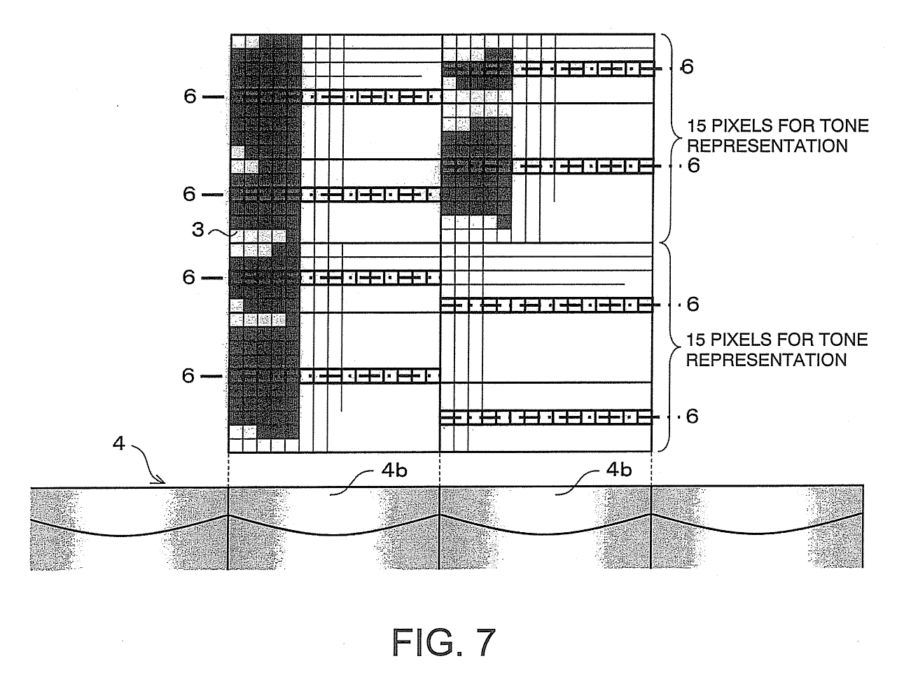

With reference now to FIGS. 6 and 7, the method of forming the dot image print 3 by dot printing according to a seventh embodiment will be described. The first to sixth embodiments pertain to the settings of reference positions for the adjacently arranged smallest units (areas) 3a that constitute an image strip group Gr. In contrast, the seventh embodiment pertains to the settings of reference positions for multiple image strip groups Gr that are each arranged for one half-cylindrical lens 4b of the dot image print 3.

In the seventh embodiment, as shown in FIG. 6, reference positions, which serve as central points for AM screening, are arranged in the form of two lateral lines across one image strip group that is arranged for a half-cylindrical lens 4b. In addition, the above reference lines of that image strip group are arranged such that the reference lines of that image strip group and the reference lines of an image strip group that lies next to the above image strip group are located at vertically different positions. Further, as shown in FIG. 7, the pixels on the reference lines 6 are defined as reference positions, and dots are printed for as many pixels as needed in longitudinal directions (upward and downward directions) of image strips from the reference positions.

Although the base color of the dot image print 3 tends to be more noticeable at positions farther away from the reference positions, by varying the vertical positions of the reference lines for each image strip group that is arranged for a half-cylindrical lens 4b, the base color of the dot image print 3 can appear in a discontinuous manner.

It should be understood that the present invention is not limited to the above embodiments.

In the above-described first to seventh embodiments, as shown by their respective diagrams, pixels are printed such that the pixels extend upward and downward from reference positions. Alternatively, only as many pixels as necessary can be printed in an upward or downward direction from the reference positions. In that case, if any pixels remain to be printed when the printing position reaches the position of the uppermost pixel of an image strip that consists of vertically aligned pixels, the remaining pixels are then printed upward from the position of the lowermost pixel of that image strip. If, on the other hand, any pixels remain to be printed when the printing position reaches the position of the lowermost pixel of an image strip that consists of vertically aligned pixels, the remaining pixels are then printed downward from the position of the uppermost pixel of that image strip.

Further, in each of the above-described embodiments, a dot image print that consists of as many image strips as necessary to represent image data is glued to the back surface of a lenticular lens sheet such that one image strip group fits the shape of each half-cylindrical lens of the lenticular lens sheet. However, the invention is not limited to the above arrangement as long as each image strip group is arranged for a half-cylindrical lens. For instance, if a stereoscopic print is assumed to be viewed from an upper central direction of the print, it is also possible to arrange image strip groups such that the viewer can stereoscopically perceive the print via half-cylindrical lenses from that direction as well. In this case, the width of an image strip group that is arranged for a half-cylindrical lens differs depending on the position of that half-cylindrical lens even if half-cylindrical lenses are constant in pitch.

Furthermore, although rectangular pixels are used as dots in the above-described embodiments, circular dots can also be used as long as they are densely arranged so as to be in contact with each other.

1. A stereoscopic print comprising:
a lenticular lens sheet that is formed by arranging a plurality of half-cylindrical lenses in a continuous manner; and
a dot image print arranged on the back surface of the lenticular lens sheet, the dot image print being formed by arranging a plurality of image strips in a continuous manner such that particular image strip groups are each arranged exclusively for one of the plurality of half-cylindrical lenses;
wherein: the plurality of image strips each include a smallest unit that enables tone representation;
for each color plate, a plurality of reference positions are set in each of the smallest units; and
amplitude-modulated screening is employed to print dots continuously in longitudinal directions of the plurality of image strips from each of the plurality of reference positions.

2. The stereoscopic print defined in claim 1, wherein the plurality of reference positions are arranged in the form of straight lines for each of the particular image strip groups that are each arranged for one of the plurality of half-cylindrical lenses.

3. The stereoscopic print defined in claim 2, wherein the plurality of reference positions arranged in the form of straight lines are located at vertically different positions among the particular image strip groups that are each arranged next to each other.

4. A stereoscopic print comprising:
a lenticular lens sheet that is formed by arranging a plurality of half-cylindrical lenses in a continuous manner; and
a dot image print arranged on the back surface of the lenticular lens sheet, the dot image print being formed by arranging a plurality of image strips in a continuous manner such that a particular image strip group is arranged exclusively for each of the plurality of half-cylindrical lenses;
wherein: the plurality of image strips each include a smallest unit that enables tone representation;
for each color plate, at least one reference position is set in each of the smallest units;
amplitude-modulated screening is employed to print dots continuously in longitudinal directions of the plurality of image strips from each of the reference positions; and
the number of the reference positions of the smallest units differs depending on the number of dots to be printed.

5. A stereoscopic print comprising:
a lenticular lens sheet that is formed by arranging a plurality of half-cylindrical lenses in a continuous manner; and
a dot image print arranged on the back surface of the lenticular lens sheet, the dot image print being formed by arranging a plurality of image strips in a continuous manner such that a particular image strip group is arranged exclusively for each of the plurality of half-cylindrical lenses;
wherein: the plurality of image strips each include a smallest unit that enables tone representation;
for each color plate, a plurality of reference positions are set in each of the smallest units;
amplitude-modulated screening is employed to print dots continuously in longitudinal directions of the plurality of image strips from each of the plurality of reference positions; and
the plurality of reference positions are located at vertically different positions among the plurality of image strips.
